(19) United States
(12) Patent Application Publication
(10) Pub. No.: US 2019/0303967 A1
(43) Pub. Date: Oct. 3, 2019

(54) SYSTEM AND METHOD TO CHARACTERIZE A USER OF A HANDHELD DEVICE

(71) Applicant: Panasonic Intellectual Property Management Co., Ltd., Osaka (JP)

(72) Inventor: Chandra Suwandi WIJAYA, Singapore (SG)

(21) Appl. No.: 15/941,144

(22) Filed: Mar. 30, 2018

(51) Int. Cl. G06Q 30/02; H04L 29/08; G06F 21/60

(52) U.S. Cl. CPC G06Q 30/0255; G06F 21/602; H04L 67/22; H04L 67/306

(57) ABSTRACT

A system that utilizes data from use of a handheld device such as a smart phone to generate an encrypted profile of the user is described. Data can be collected from use of the camera, microphone, accelerometer, GPS and/or software applications. An algorithm can generate a digital profile card that includes characteristics of the user such as emotion, habit and personality. The profile can be shared with external devices and media platforms for targeted advertisements. The profile can also be shared with IOT devices and vendors.

### TECHNICAL FIELD

The present invention relates to a system and method to characterize the user of a smart phone, and more specifically, to a method of utilizing data from use of a handheld device or smart phone to generate an encrypted profile based on the emotion, habits and personality of the user.

### BACKGROUND

Advertising refers to an act of drawing attention to one's product or service. Conventional forms of advertising include billboards, printed media, radio and television. A product or service is presented with the goal of reaching the largest audience possible. However, this type of “blanket” advertising can be expensive and impractical, particularly with modern consumers who may rely on social media and internet services for information and entertainment.

To be most effective, an advertisement should reach a proper (i.e. target) audience. With targeted advertising, online advertisers use methods to target the most receptive audience based on the product or service the advertiser is promoting. For example, a type of apparel may appeal to a particular demographic. An advertiser can place an image of apparel with a trademark in a magazine that is commonly viewed by a person of that demographic (i.e. age, gender, income level and/or employment). Psychographic characteristics, such as a consumer's values, personality, attitudes, opinions, lifestyles and interests can also be considered.

The growth of e-commerce has led to a concomitant increase in on-line advertising. Online advertising uses the Internet to deliver promotional messages to consumers. It includes e-mail (“spam”) marketing, search engine marketing (SEM), social media marketing, display advertising (e.g. web banner advertising), and mobile advertising.

Metadata is a key component of targeted advertising. Today, most web pages have metadata embedded in them. Web search engines build up vast indexes that use page text and its attendant metadata to provide relevant search results to users. Advertisers attempt to target the most receptive audiences with certain traits, based on the product or service the advertiser is promoting.

For example, a person could use a web browser to search for airline flights to Japan. Metadata in the form of “cookies' from websites visited by him/her is stored on the computer by a web browser of the user. Cookies are sent back and forth between an Internet server and the browser, which allows the user to be identified and/or to track their activities. Thereafter, the person could receive advertisements such as banner ads related to travel in Japan such as hotel, car rental, tour and flight information.

Recent efforts by marketers have focused on developing profiles of consumers based on their online activity. A user may include identifying information when they register for an e-mail address or social media account. Behavioral variables, such as “key word” searches, browser history, purchase history, and other recent activity can also be used to develop a profile on a user. Thereafter, targeted internet advertising can focus on certain traits and so that it is directed to consumers who are likely to have an interest in a product or service rather than those who do not match the attribute of a product.

For example, U.S. Patent Application No. 20140040031 describes a method of advertising to a targeted buyer. An application profiles a consumer in a particular location then queues pre-loaded advertisements from an out-of-home (“OOH”) medium. While the invention aims to remotely target advertisements appropriate to a particular consumer, data is limited to the consumer's physical location.

Similarly, U.S. Patent Application No. 20050222901 describes a method of targeted advertisement based on ad search keywords. Advertisement information is determined using aggregated selected document-to-query information associations. While the invention aims to target advertisements appropriate to a particular consumer, data is limited by the consumer's use of key word searches.

U.S. Patent Application No. 20110295701 describes a web-based system and method to implement digital out-of-home advertisements. A computer compiles a list of key words based on the consumer's use of a home computer. A network is used to display advertisements at remote locations where they are likely to be seen by the consumer. While the invention allows advertisements to be presented at remote locations, data available for targeted advertising is limited by the consumer's use of key word searches.

Conventional methods to target advertisements based on computer use also encounter technical obstacles. A user may choose to browse sites on the internet anonymously. Software can be used to limit cookies and/or the collection of metadata. Moreover, a computer may have multiple users. Further, only limited information can be gathered from searches and browser history. The methods rely on assumptions and extrapolations that can be inaccurate and/or ineffective. For example, a person may have different interests and objectives than others in their demographic.

Accordingly, there is a need for a system and method to more accurately and reliably characterize a consumer for services such as targeted marketing. It should utilize information beyond key word searches and predicted demographics. The system should utilize data from smart phone activity and use to generate an encrypted profile based on the emotion, habits and personality of the user. It should also allow data to be shared with external devices and media platforms.

### SUMMARY OF THE INVENTION

A method for characterizing the user of a handheld device is described. The method is comprised of the steps of (a) collecting data from the environment, use, movement and/or location of a handheld device, (b) analyzing the data to determine at least one emotion of the user based on activities and/or behaviors, (c) analyzing the data to determine at least one habit of the user based on patterns of activities of the user and tendencies of behaviors of the user and (d) analyzing the data to determine at least one personality based on long term behavior and/or emotional characteristics of the user. The determined emotion, habit and personality can be stored in a memory for characterizing the user.

A handheld device for characterizing a user is also described. The handheld device comprises (a) an image sensor, (b) a microphone, (c) an accelerator, (d) a global positioning system (GPS), (e) one or more applications and (f) a digital profile card. Data can be collected with the image sensor, a microphone, accelerator, GPS, and computer applications and analyzed to identify actions, movement and locations of the user. The actions, movement and locations of the individual can be used to identify one or more emotions, habits and personalities that are stored on the digital profile card.

Embodiments include a system for targeted advertisement to a user. The system comprises the handheld device, a database of advertisements and one or more authorized devices. Advertisements can be selected from the database based on data contained on the digital profile card. The advertisements can be displayed on the authorized devices.

Embodiments also include a system for targeted advertisement to an individual based on their use of a handheld device comprising (a) a sensor to detect a handheld device with a digital profile card, (b) a signal processing unit, (c) a database of advertisements and (d) one or more digital signs/displays. The signal processing unit can decrypt data on the digital profile card. One or more advertisements can be selected by the signal processing unit based on the decrypted data and displayed on the digital signs/displays.

### INTRODUCTION

A first aspect of the invention is a system that uses a handheld device to collect data on a user for targeted advertising and/or use with other electronic devices.

A second aspect of the invention is a system that collects data from the use of a handheld device to characterize the user based on his/her emotion, habits and/or personality.

A third aspect of the invention is a computer implemented system that analyzes data collected from components of a handheld device or smart phone, including the camera, microphone, accelerometer, global positioning system (GPS) and/or software applications.

A fourth aspect of the invention is a computer implemented system that uses data from the use of a handheld device or smart phone to develop a digital encrypted profile card of the user.

A fifth aspect of the invention is a digital encrypted profile card that contains information about the user of a handheld device or cell phone, including his/her emotion, habits, personality and location.

A sixth aspect of the invention is a method of utilizing a digital encrypted profile card for targeted advertising on external devices (e.g. digital signs/billboards).

A seventh aspect of the invention is a system that links the profile of the user of a handheld device or smart phone with external devices and media platforms for targeted advertisement.

An eighth aspect of the invention is a system that links the profile of the user of a handheld device or smart phone with external “IOT” devices.

### BRIEF DESCRIPTION OF THE FIGURES

The drawings described herein are for illustrative purposes only of selected embodiments and not all possible implementations, and are not intended to limit the scope of the present disclosure.

The summary above, as well as the following detailed description of illustrative embodiments, is better understood when read in conjunction with the appended drawings. For the purpose of illustrating the disclosure, exemplary constructions of the disclosure are shown in the drawings. However, the disclosure is not limited to specific methods and instrumentalities disclosed herein. Wherever possible, like elements have been indicated by identical numbers.

FIG. 1 depicts the components used by an embodiment in the process of data fusion.

FIG. 2A depicts an embodiment of a digital profile card.

FIG. 2B depicts a digital profile card with defined categories.

FIG. 3 depicts a digital profile card and some exemplary uses.

FIG. 4 is a flow chart that depicts the process of data collection for a digital profile card and the subsequent use of the digital profile card.

FIGS. 5A, 5B and 5C depict digital profile cards with exemplary emotions, habits and personalities.

FIGS. 6A and 6B depict digital profile cards with cumulative habits and personalities.

### DETAILED DESCRIPTION OF THE INVENTION

### Definitions

Reference in this specification to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but not other embodiments/aspects. Embodiment and aspect can be in certain instances be used interchangeably.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The term “accelerator” or “accelerometer” refers to an instrument for measuring acceleration or for detecting and measuring vibrations. Accelerometers detect axis-based motion sensing and can be found in fitness trackers as well as handheld devices such as smart phones.

The term “algorithm” refers to a procedure for solving a mathematical problem in a finite number of steps that frequently involves repetition of an operation.

The term “application” or “App” refers to a software application, usually as downloaded by a user to a mobile device or tablet computer.

The term “artificial intelligence” or “AI” refers to intelligence exhibited by machines, rather than humans. The term, as applied herein, refers to when a machine mimics “cognitive” functions that humans associate with other human minds, such as “learning” and “problem solving.”

The term “authorized device” or “authorized party” refers to an apparatus, individual, group of individuals or entity with authority to access information (i.e. information contained in one's digital profile card). Endpoint authentication can be used by an authorized device/party as a level of security.

The term “Bluetooth” is a registered trademark of Bluetooth SIG, Inc. USA and refers to a wireless technology standard for exchanging data over short distances (using short-wavelength UHF radio waves in the ISM band) from fixed and mobile devices, and building personal area networks (PANs).

The term “cloud,” “cloud computing,” or “cloud technology” refers to an information technology (IT) paradigm that enables ubiquitous access to shared pools of configurable system resources and higher-level services that can be rapidly provisioned with minimal management effort, often over the Internet. Cloud computing relies on sharing of resources to achieve coherence and economy of scale, similar to a utility.

The term “cookie” or “cookies” refers to a small file or part of a file stored on a World Wide Web user's computer, created and subsequently read by a website server, and containing personal information (such as a user identification code, customized preferences or a record of pages visited).

The term “computer learning” or “machine learning” refers to an application of artificial intelligence (AI) that provides systems the ability to automatically learn and improve from experience without being explicitly programmed. Machine learning focuses on the development of computer programs that can access data and use it to learn for themselves.

The term “cognitive” refers to of, relating to, being, or involving conscious intellectual activity (as thinking, reasoning, or remembering).

The term “demographic” refers to the statistical characteristics of human populations (such as age or income) used especially to identify markets. It can also refer to a market or segment of the population (e.g. identified by demographics, trying to reach a younger demographic).

The term “digital content” or “digital media content” refers to content that exists in the form of digital data stored on digital or analog storage in specific formats. Forms of digital content include information that is digitally broadcast, streamed, or contained in computer files (e.g. video, audio and images). It can include any type of digital information (e. g. news, advertisements, updated weather forecasts, maps, etc.).

The term “digital display” refers to the used technologies such as LCD, LED and Projection to display content such as digital images, video, streaming media, web pages, weather data, restaurant menu, or text. Digital displays can be found in public spaces, transportation systems, museums, stadiums, retail stores, hotels, restaurants, and corporate buildings etc.

The term “encryption” refers to the process of transforming plaintext using a cipher into ciphertext to make it unreadable to anyone except those possessing the key. Decryption is the process of transforming that ciphertext back into plaintext, using the key.

The term “endpoint authentication” refers to a security mechanism designed to ensure that only authorized devices can connect to a given network, site or service. The approach is also known as device authentication. The password response sent from the registered device verifies that the user is connecting from an authorized endpoint.

The term “fusion” or “data fusion” refers to the process of integration of multiple data and knowledge representing the same real-world object into a consistent, accurate, and useful representation.

The term “GPS” or “Global Positioning System” refers to a radio navigation system that allows users to determine their location (often with a handheld device such as a smart phone).

The term “IOT” or “Internet of Things” refers to a network of physical devices, vehicles, home appliances and other items embedded with electronics, software, sensors, actuators, and network connectivity which enable them to connect and exchange data.

The term “metadata” refers to data that describes other data. It provides information about a certain item's content. An image may include metadata that describes how large the picture is, the color depth, the image resolution and when the image was created. Metadata of a text document may contain information about how long the document is, who the author is, when the document was written, and a short summary of the document.

The term “metatag” refers to metadata that is included on web pages. Description and keywords meta tags are commonly used to describe the content of the web page content. Most search engines use this data when adding pages to their search index.

The term “module” refers to a self-contained unit, such as an assembly of electronic components and associated wiring or a segment of computer software, which itself performs a defined task and can be linked with other such units to form a larger system.

The term “passive sensing” refers to automated collection of smartphone generated data, for example by the accelerometer, GPS and microphone (e.g. to record ambient noise levels). The camera(s) can also be used passively to detect the environment and lighting conditions. This is in contrast to “active sensing” tasks wherein a smartphone user takes actions such as making a phone call, taking a picture, tagging a place or sending an e-mail/text message.

The term “smart phone” refers to a handheld personal computer with a mobile operating system and an integrated broadband cellular network connection. Other components of a smart phone typically include a telephone, digital camera and video camera, GPS navigation, a media player, clock, calculator, web browser, handheld video game player, flashlight, compass, an address book, note-taking, digital messenger, an event calendar, etc. Smart phones can also include one or more of the following sensors: magnetometer, proximity sensor, barometer, gyroscope, or accelerometer.

The term “synthetic data” refers to any production data applicable to a given situation that are not obtained by direct measurement.

Other technical terms used herein have their ordinary meaning in the art that they are used, as exemplified by a variety of technical dictionaries.

### Description of Preferred Embodiments

The particular values and configurations discussed in these non-limiting examples can be varied and are cited merely to illustrate at least one embodiment and are not intended to limit the scope thereof. For example, although embodiments are described for use with handheld device or smart phone, the embodiments can be used with other digital devices, including tablet computers, personal computers and wearable electronic devices (e.g. smart watches). Further, multiple devices can be linked to contribute data to for collective analysis.

The embodiments recognize that people have the ability to assess the current “atmosphere” and sometimes “read” the mind of another person to a high degree of accuracy. For example, a question or statement can be interpreted, understood or perceived in different ways. A person can be asked the question, “Working hard?” There is a literal meaning to the question. There are also facetious and sarcastic meanings. Knowing the personality and mood of the speaker can help determine the intended meaning. Context can also be used. The question presented mid-day in an office setting may have a different meaning then when presented in a social setting.

The embodiments also recognize that smart phone activity can be used to characterize a person. The accuracy and degree that the user is characterized increases as data accumulates over time. Once properly characterized, it is possible to interpret a question or statement that could otherwise likely only be interpreted by a friend or close acquaintance. Data collected by a smart phone can also be used to decipher context. Once characterized, the meaning behind a statement or query (e.g. “working hard?”) can be properly interpreted, particularly when context is also considered.

The embodiments also recognize the prevalence of smart phone use in many settings. People often carry their smart phone throughout the day and evening. The smart phone is used frequently for a myriad of tasks (e.g. telephone conversations, as a web browser, to view news, for social media, for directions, for global positioning system (GPS) and as an agenda/calendar). Smart phone use can reveal much about a person, specifically their emotion, habit and personality. For example, the GPS and calendar can identify the work and leisure schedule of a user. The texting/speaking activities along with use of Apps by a user can provide evidence of context and mood.

According to one embodiment, a person (i.e. smart phone user) is characterized to develop an “EHP Profile.” The EHP profile includes an Emotion, a Habit and a Personality. Emotion tends to be a dynamic factor that varies with context and circumstances. Habit tends to be a more constant tendency that is similar from one day to the next. Personality is a long-term characteristic that will likely remain unchanged during the use of the smart phone. The three factors (short, medium and long term characteristics) provide more insightful information about a person than their demographic.

### Generation of Digital Profile Card

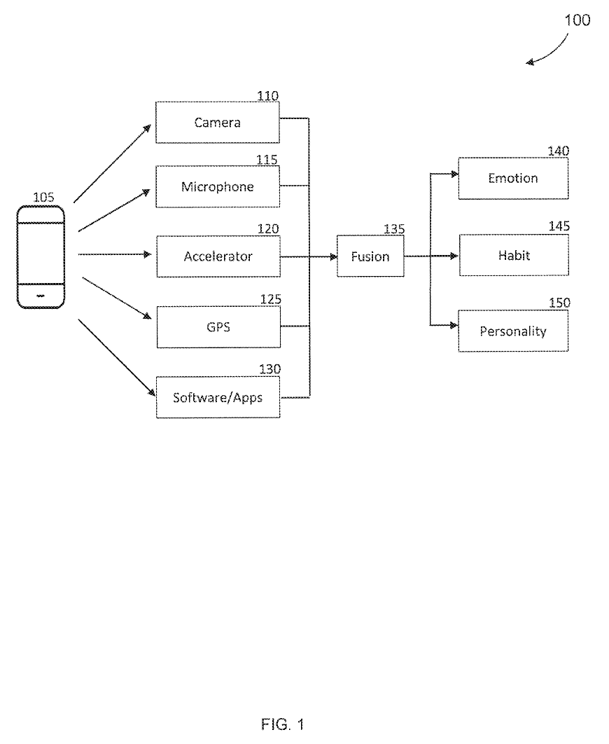

FIG. 1 depicts a process 100 for characterizing the user of a handheld device such as a smart phone. The smart phone 105 includes a processor and memory and is depicted with other conventional components. In one embodiment, a camera 110, microphone 115, accelerator 120, global positioning system (GPS) 125 and software applications 130 are used to characterize the user. Data from each component can be collected and analyzed to construct an “EHP profile” for the user.

Camera 110 use can reveal much about a smart phone user. Photos taken by the user can be analyzed for content. Those that include groups of individuals can suggest a festive event. This can be supported by considering the location, date and time that a photo is taken (e.g. weekend or known holiday). It is also possible for a smart phone to “passively” use the camera to independently record images and video. The camera can detect images intermittently in a low resolution mode to detect environment and provide evidence of context.

Similarly, a microphone 115 and audio recordings can be used to collect data about the user. The tone and frequency of phone calls can provide evidence of mood. For example, a higher pitch voice with intermittent gestures (e.g. laughing) can indicate a happy/playful mood. It is also possible to use key word recognition (i.e. user speech recognition) to identify context and associate particular words with the mood of the user. Music and audio can also be detected and identified for evidence of mood of a user and indicate context. The location, date and time of microphone use can also be considered (e.g. weekend or known holiday).

An accelerator 120 can be used to detect activity of a cell phone user. Most smart phones can track steps without a separate fitness tracker. The smart phones can also detect when the phone is moving in a vehicle. Together, this data can indicate a daily commute, walking/running and/or exercise routine of a user.

GPS 125 can show the location of a user in real time. The location of the smart phone from day to day can reveal much about the lifestyle, schedule and habits of a user. Proximity to landmarks and businesses can be used to distinguish leisure events from others. Dates and times can also be considered with location as further evidence of leisure time (e.g. weekends and evenings).

The use of software and “Apps” 130 can also reveal much about a smart phone user. Messaging, e-mail and social media are typically the most common actions performed on smart phones. Key word recognition (i.e. in text messages and e-mails) can identify context and associate particular words with the mood of a user. The type of Apps used on a phone and their frequency of use can also reveal much about a person and their mood. For example, financial news and investment may indicate work and provide data on one's employment and long term goals. Whereas the use of music, games and photo-sharing apps will suggest leisure and provide data on interests and hobbies.

Data collected from the camera 110, microphone 115, accelerator 120, GPS 125 and software 130 can be collected and analyzed with a fusion algorithm 135 to characterize the user of the smart phone. The fusion step can allow data to be considered individually (e.g. an interest in a particular food) as well as collectively (e.g., a habit of visiting a particular café at a particular date and time). The user can be characterized according to three categories: Emotion 140, Habit 145 and Personality 150. By considering the three categories, the smart phone user can be more accurately characterized for targeted marketing and other services.

### Emotion

Emotion 140 is a dynamic variable (i.e. typically short term). It includes a conscious mental reaction (e.g. cheerfulness, anger or fear) subjectively experienced as strong feeling usually directed toward a specific event that can be accompanied by physiological and behavioral changes in the body. Many emotions can be identified such as, for example, tense, nervous, stressed, upset, sad, depressed, bored, fatigued, calm, relaxed, serene, content, happy, elated and excited.

The emotion of a smart phone user can be gauged by the combination of data collected by the smart phone components. Recent actions and behaviors (e.g. within the past one to two hours) can be most relevant in determining mood. For example, speaking with a higher pitch can indicate that one is in a good mood. In contrast, speaking with a lower pitch and high volume can indicated that one is in a bad mood.

The camera can gauge emotion by detecting the facial expression through passive sensing and/or active sensing. An image can be analyzed to estimate emotion based on feature points on a subject's face. See, for example, US 2017/0105662 which describes an approach to estimating an emotion based on facial expression and analysis of one or more images and/or physiological data.

The accelerator can also provide data for emotion by tracking movement. For example, if the phone is in a pocket or bag it could provide data on the movement of the user. A happy user might have more upbeat and rhythmic movements. Whereas a sad/tired user might move at slower pace and an angry user might move more erratically.

Patterns of activity can also be associated with a good mood. The user may be in more positive moods after exercising or visiting a fitness center or before visiting a shopping center or restaurant. Other activities can be associated with good moods such as taking many pictures within a short period of time and/or using particular apps. If data is insufficient to determine mood (e.g. the smart phone is not in use), emotion can be reverted to a baseline or neutral mood.

### Habit

Habit 145 can be considered a mid-term/medium-frequency characteristic. It refers to a repetitive action that is gauged or tracked over a longer period of time than emotion (e.g. days, weeks and months). It can include the prevailing disposition or character of a person's thoughts and feelings. Many habits can be identified such as, for example, a tendency to buy novels or beauty care products, reading books rather than magazines, a preference to running instead of swimming as an exercise, a tendency to watch action movies or listen to a specific type of music by a certain artist.

Habits of a smart phone user can be gauged in a similar manner to emotion. However, actions and behaviors are detected and analyzed from day to day. Patterns of activity can be recorded with inclusion of locations and times. For example, a smart phone can often identify locations of home and work through this means along with the usual times and routes of commutes using GPS. It is also possible to identify where a user routinely dines, shops, exercises, etc. A user may prefer to go to mall “A” instead of mall “B,” or one particular store over another. The accelerator can also be used to track movement and determine habits.

Sound can also play an important role in determining habits. The microphone can record and identify key words, particularly if operated through passive sensing. Relevant key words can include the title of music, a food preference, a favorite animal, a favorite color, a liked activity, a book, a movie, etc. which can be a basis for habit. The camera can play a role by, for example, determining a preferred hair style or fashion style. Data collected from the use of software/apps (e.g. search history, streaming content, etc.) can also contribute to identifying habit.

Examples of other habits that can be identified include: checks e-mail/social media frequently, exercises daily, wakes up early/late, visits particular cafes and convenience stores often, listens to a type of pop music while commuting, eats lunch at work often, usually visits nightclubs and pubs on Friday evenings, uses handheld device/smart phone at night, often works late on Tuesdays, drives fast on weekends, etc.

### Personality

Personality 150 is considered a long term characteristic. It can be defined as a behavior pattern acquired by frequent repetition or physiologic exposure that shows itself in regularity or increased facility of performance (e.g. over the course of months and years). Many personalities can be identified such as, for example, impulsive, thoughtful, extrovert, introvert, patient, impatient, cheerful and gloomy.

Behavioral and emotional characteristics of an individual can define one's personality. The personality of a smart phone use can be gauged by associating moods and actions with their environment and context. Personality can be characterized over longer periods of time as data is collected. For example, a user can be identified as “impulsive” based on sudden mood changes (e.g. suddenly becoming irritated when driving). The shopping habits (e.g., spontaneous purchases) of a user can also suggest an impulsive personality.

Sound can be used to determine personality. Individual emotions and/or expressions can be acknowledged over time to gauge a personality. For example a “talkative, bubbly” person can be identified by frequently speaking with an upbeat, positive tone. A short tempered person can be identified by frequent screaming and yelling. Whereas an introvert could be identified by slower speech that has a lower tone. By using GPS, movement of the person can be tracked to derive data on personality. If the person frequently roams to places far from their work and home then he/she may potentially like to explore. If the person tends to drive above speed limits, he/she can be categorized as impatient or a “risk taker.” If the person appears to be confined to nearby locations and stores, then he/she may be an introvert.

Interactions and behaviors can be monitored with software and/or apps to gauge a personality. For example, searches and downloads of slow music can suggest that a person is gloomy. The camera can also play a role to determine personality. For example, non-mainstream and/or exotic facial make-up can indicate that a person is eccentric or a social non-conformist.

Other personalities that can be identified include adventurous, agreeable, allocentric, ambitious, amiable, athletic, cheerful, competitive, conservative, cultured, disciplined, emotional, enthusiastic, friendly, hardworking, healthy, humorous, idealistic, imaginative, independent, methodical, neat, observant, optimistic, outspoken, passionate, patriotic, perfectionist, personable, playful, practical, precise, principled, prudent, punctual, rational, realistic, reflective, relaxed, reliable, resourceful, respectful, responsible, romantic, scholarly, sentimental, shrewd, sociable, sophisticated, spontaneous, sporting, steadfast, sympathetic, tidy, vivacious, wise, witty, youthful, etc.

In this regard, emotion is determined from a first time period which can be minutes or hours (e.g. one minute to 24 hours). Habit is determined from a second time period that is longer than the first time period, typically several days (e.g. one day to six months). Personality is determined from a third time period that is longer than the second time period (e.g. one month to two years). Data can accumulate for each category from regular use of the handheld device or smart phone to more accurately define the emotion, habit and personality of the user. In another embodiment, the user can adjust settings on the handheld device. He/she can adjust the duration of the first time period, the second time period and/or the third time period.

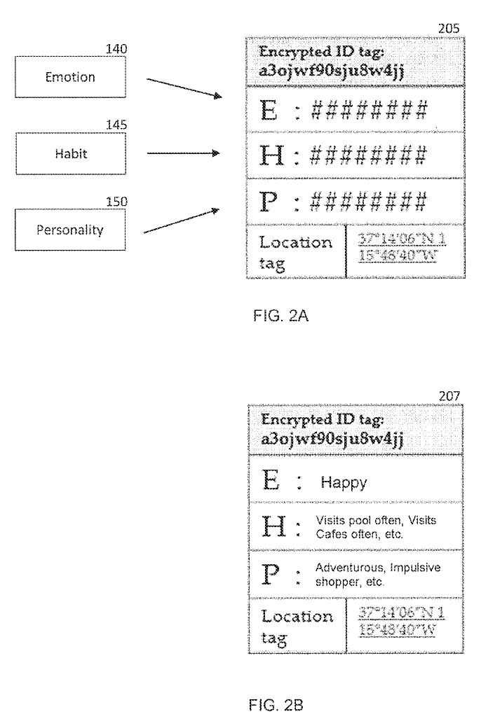

In one embodiment, the categories are combined to generate a digital profile card for the smart phone user. FIG. 2A depicts an exemplary embodiment of a digital profile card 205 and its components. The profile card can include values to represent the emotion 140, habit 145 and personality 150 of the user. To protect the privacy of the user, the user profile card can be encrypted. The profile card can include an ID tag to allow an authorized party to identify and decrypt the profile card. A location tag that is regularly or continuously updated can also be included. FIG. 2B depicts a user profile card 207 with defined categories. In this example, the user is characterized as having a “happy” mood. Their habits are defined as “visiting cafes and pools often.” Their personality is characterized as “adventurous, impulsive shopper.”

Because privacy can be a common concern among smart phone users, the user of a smart phone can remain anonymous. It is not essential for the user of a smart phone to register for an account or enter personal information. Further, it is not necessary to identify the user of the smart phone even though the user maintains a profile card. Their name (and other personal information) is not associated with profile card. A party who accesses a card can be informed of “a person with a certain profile” without knowing anything about the person. As another safeguard, the profile can be generated locally and the master profile stored only in the phone, thus keeping it “personal.” Further, the smart phone can maintain discretion to one-way and two-way cloud communication. These efforts create a high degree of privacy and security for the smart phone user.

### Use of Digital Profile Card

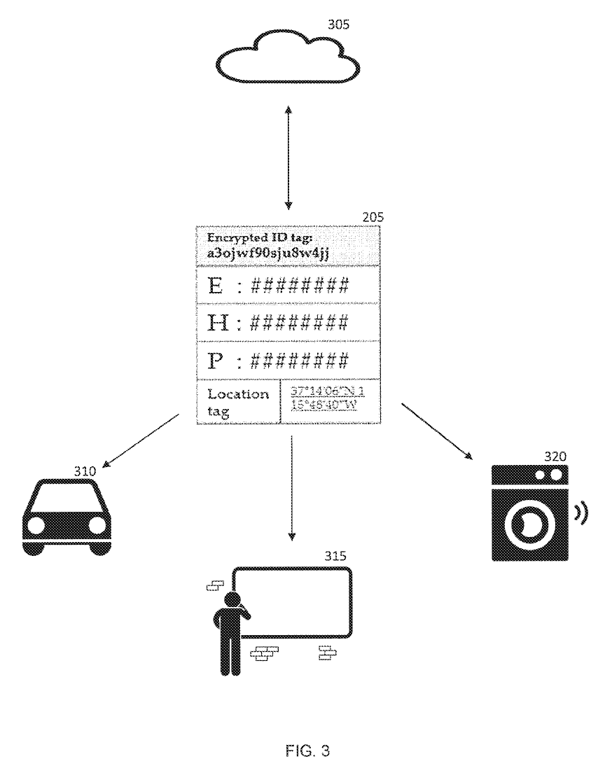

FIG. 3 depicts a digital profile card 205, its cloud 305 connection and its access by authorized devices and parties (310, 315, 320). Authorized parties can include vendors and advertisers. Authorized devices can include digital signs/billboards and a myriad electronic apparatus with internet/cloud access.

Cloud 305 communication can be “one-way” or “two-way.” With one-way communication, data is collected into a storage medium using the cloud. Data is not sent back to the cell phone 105. A smart phone user can choose one-way communication for greater privacy. Two-way communication allows the cell phone to receive information from the cloud. Two-way cloud connectivity can offer additional services and interactivity to a smart phone user. For example, a user can receive targeted advertisements from their browser. The user can also receive personalized non-commercial information (e.g. public service announcements, weather advisories, etc.).

An authorized device can include an automobile (self-driven and/or autonomous) 310 that has Bluetooth, internet and/or cloud connectivity. The profile card can assist in vehicle navigation by identified habits. An interface, such as a GPS monitor, can provide information and personalize messages to the user. Other features in the automobile can also be personalized for a smart phone user (e.g. seat position, climate control, stereo settings, driving mode, etc.).

A digital sign/display 315 can also be an authorized device. Painted billboards are becoming less common, particularly in high traffic areas. They are being replaced with digital signs/displays to provide directions, exhibitions, marketing and outdoor advertising. Similarly, digital monitors can be used to display multiple messages and allow more dynamic advertisements. A digital sign/display or monitor can be equipped with hardware to identify one's profile card. It can detect when a smart phone user is approaching. Based on their profile card, it can post an appropriate advertisement or message. This allows personalized messages and advertisements to be presented to a user in their living and working environment. Audio (e.g. preferred music) and/or a personalized audio messages can also be incorporated into the digital sign/display 315.

In an exemplary embodiment, a digital sign/display 315 detects smartphone users with EHP profiles within a vicinity or radius (e.g. within one kilometer of the digital sign/display). A processor can identify one or more personalized advertisements and/or messages that are appropriate to each smartphone user within the radius. Movement of each user can also be monitored. When a user enters an area where the sign is visible, the personalized advertisements and/or messages for the particular viewer can be displayed. When the user is no longer within an area where the sign is visible, the display can be changed. If there are no users nearby, the digital sign/display 315 can revert to a public (non-personalized) advertisement/message. This allows targeted advertising to a smart phone user on a public billboard or other digital media outside of their home/work environment

Various Internet of Things (IOT) devices 320 can also be authorized to access digital profile cards. Such devices can include home appliances, smart door locks, home light switches, heating, air conditioning as well as kitchen appliances. The devices can be synchronized with other web-based hardware devices (e.g. personal assistants). A user can receive personalized information related to a device. For example, a message can be relayed to their smart phone if their air conditioner is due for service and he/she is likely to use it based on his/her habit.

Other authorized parties such as third party vendors (not shown) can also be provided with a decryption key to identify a particular smart phone user for services (e.g. VIP privileges). For example, a user can be given the option to be contacted directly from a vendor. The vendor can provide incentives to potential customers for accessing their profiles.

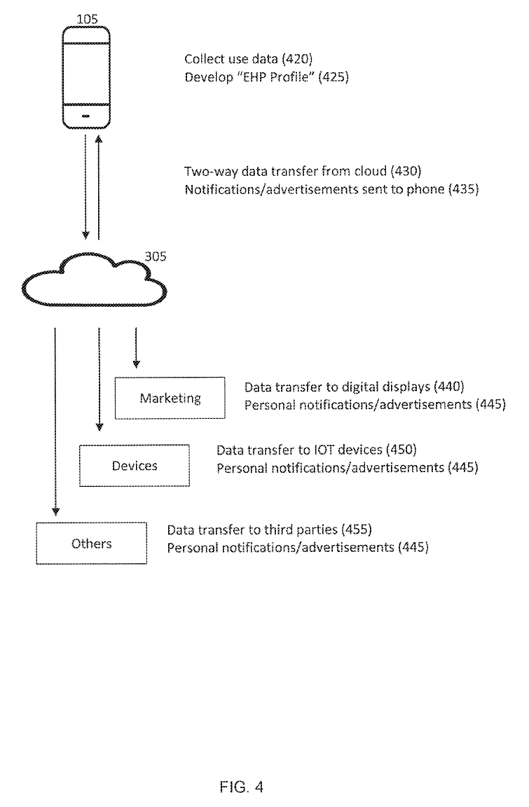

FIG. 4 depicts the process of data collection 420 to develop a profile card 425 and its subsequent uses. As a smart phone is used, data can be collected to construct a specific transmissible personal profile derived from three elements: emotion, habit and personality. Data from other sources can be considered in identifying these elements. For example, a user can be prompted to answer a series of questions to reveal information about himself/herself. Data collected from texts, e-mails and social media activity can also be considered.

Two-way data transfer from the cloud 430 is depicted. This allows notifications and advertisements to be sent to the smart phone 435. Data transfer from the cloud 305 can be provided to one or more content providers. A content provider can be an individual or organization that provides digital content such as advertisements. The content providers can use digital displays 440 to communicate personal notifications and targeted advertisements 445. Data can also be shared with IOT devices 450 and authorized third parties 455 for personal notifications and advertisements 445.

### Working Example

### Use of EHP Profile Card for Targeted Advertising

The invention recognizes that a handheld device such as a smart phone can be used to characterize its user. Data can be collected from passive and/or active use of the camera, microphone, accelerometer, GPS and/or software applications. The device can compile and analyze the data to identify the environment, actions, movement and/or locations of the user. The environment, actions, movement and/or locations of the user can be used to to identify emotions, habits and a personalities that are stored on a digital profile card. Because data can be gathered and analyzed continuously, a dynamic profile can be compiled and transmitted in real time. This allows targeted marketing that can break away from conventional profiling (e.g. based on gender, age, work, etc.). Unlike conventional approaches, context can also be incorporated and considered.

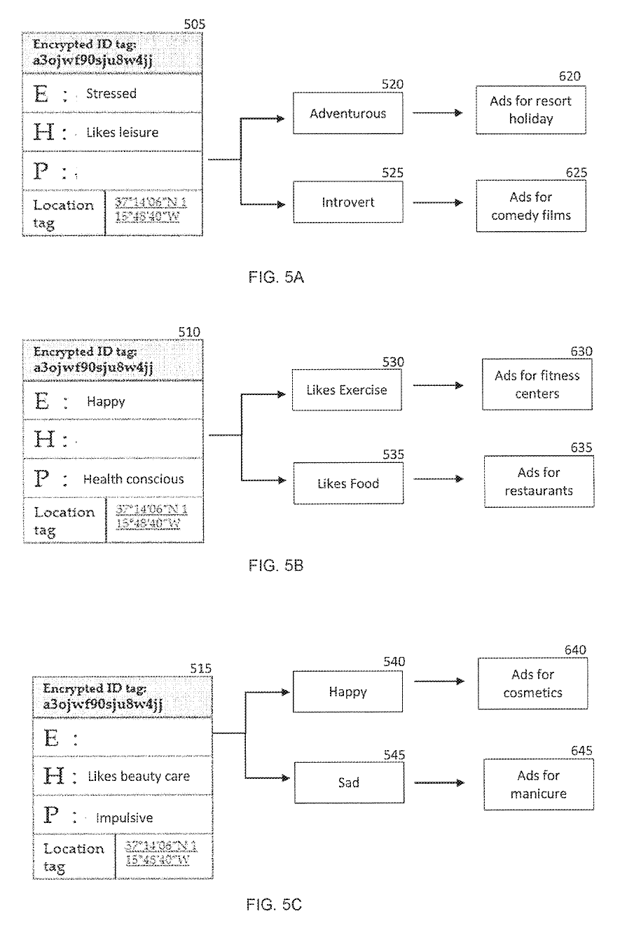

FIG. 5A depicts an exemplary EHP profile card 505 for a user. As a smart phone is used, data can be collected to construct a specific transmissible personal “EHP” profile with three elements: emotion, habit and personality. For this individual, data collected from their smart phone has indicated that their emotion is “stressed” and a habit is “likes leisure.” Intensity of conversations and key words can indicate his/her stressed mood. Frequent visits to beaches and parks along with regular use of gaming applications can indicate his/her leisure habit.

For such an individual, personality may dictate the types of advertisements that are presented to them. For an adventurous personality 520, advertisements for resort holidays 620 can be appropriate. Likewise, for an introvert 525, advertisements for comedy films 625 can be more appropriate.

Similarly, FIG. 5B depicts an EHP profile card 510 for another user. Data collected from their smart phone has indicated that their emotion is “happy” and a personality feature is “health conscious.” Casual conversations and use of social media can indicate his/her happy mood. Frequent visits to natural food stores and fitness centers can indicate his/her personality trait of health consciousness.

For such an individual, habit may dictate the types of advertisements that are presented to them. For person who likes exercise 530, advertisements for gyms or fitness centers 630 can be appropriate. Likewise, for a person who likes food 535, advertisements for cafes and restaurants 635 can be more appropriate.

FIG. 5C depicts an EHP profile card 515 for a user with a personality deemed to be “impulsive.” “Beauty care” is an identified habit. Frequent purchases of cosmetics and visits to spas/salons can indicate his/her habit of beauty care. Impulsiveness can be determined by quick responses/actions to messages and advertisements.

For such an individual, mood may dictate the types of advertisements that are presented to them. For a happy mood 540, advertisements for cosmetic products 640 can be appropriate. Likewise, when they are in a sad mood 545, advertisements for manicure/pedicure services 645 can be more appropriate.

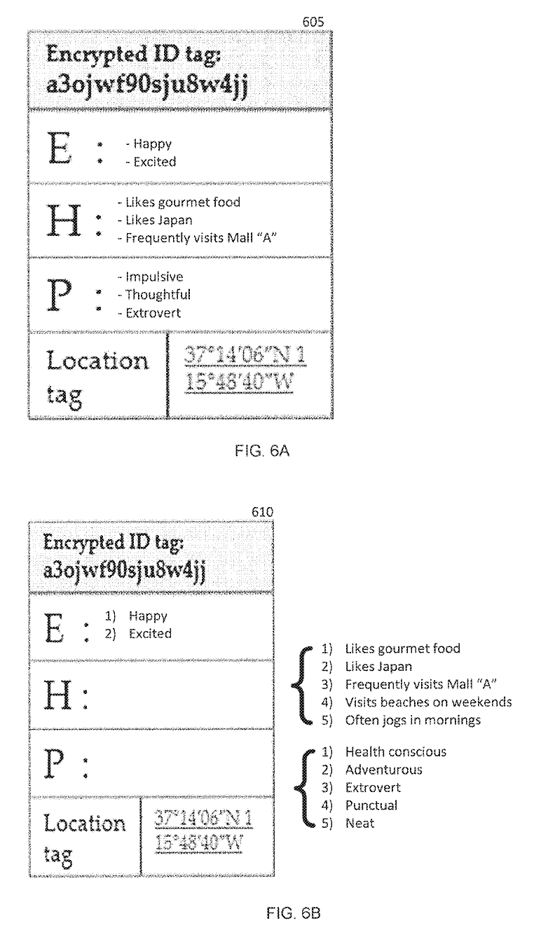

In another embodiment, data accumulates to more accurately characterize the user of a handheld device. Multiple emotions, habits and personalities can be collected and stored on an EHP profile card. FIG. 6A depicts an EHP profile card 605 with multiple characteristics for each category. In this example, the user is identified with two emotions, “happy” and “excited.” Three habits are identified: (1) likes gourmet food, (2) likes Japan and (3) frequently visits Mall “A.” Personality is identified as: (1) impulsive, (2) thoughtful and (3) extrovert. Based on these characteristics, the system can select an appropriate advertisement such as a sushi restaurant near the mall that the user frequently visits. An advertisement for a fast food outlet in a different location would probably be less appropriate.

It is also possible to rank individual emotions, habits and/or personalities. In selecting content, more weight/influence can be given to those with higher ranks. The characteristics can be ranked according to certainty as well as relevance. FIG. 6B depicts an EHP profile card 610 with multiple characteristics in each category that are ranked according to certainty and relevance. In this example, two emotions are detected, “happy” and “excited.” “Happy” can be ranked higher if the user's actions are more indicative of this characteristic.

Similarly, the habit “likes gourmet food” can be given a higher rank than others. Frequent actions such as visits to specialty stores/restaurants and regular access to food/cooking content can increase the certainty of this habit. Relevance can include context and circumstances. For example, the relevance can be higher because of the time and location. An advertisement for a restaurant may be more appropriate during early evening when the Individual is near a neighborhood with cafes and restaurants. Similarly, the personality of “health conscious” may be ranked higher than others based on certainty and/or relevance. The individual's actions may suggest that he/she is on a diet and the time/location may suggest that he/she is getting a meal.

The ranked emotions, habits and/or personalities can thereafter be adjusted based on the individual's actions. “Likes Japan” can be given a lower rank if the individual ceases to demonstrate an interest in Japan (e.g. no further web activity or key words are detected). “Visits beaches on weekends” can be ranked higher based on recent, frequent weekend trips to beach areas. In this case, it may be more appropriate to promote products and services that are available and/or useful for beach activities on weekends.

### Non-Commercial Uses of EHP Profile

There are myriad uses of an EHP profile outside of advertising and marketing. For example, public service announcements and safety messages can be enhanced with access to EHP profiles.

Messages related to safety can be sent to drivers. The system can predict a destination of a driver based on habit. If there is a hazard or obstruction in that route of the driver, a message can be sent to the driver. Similarly, the system can identify nearby drivers and their EHP profiles. A driver can be put on alert of a nearby driver whose profile indicates that they are “angry,” “likes to drive fast” and/or is “impulsive.”

Similarly, EHP profiles can be used at public gatherings such as sport matches and concert halls. Attendees can be identified by their EHP profiles. An attendee can be put on alert of a nearby person whose profile indicates that they are “angry,” “likes an opposing team” and/or is “reckless/impulsive.” The same information can be sent to an authority or agency to increase security and/or take steps to prevent violence.

### Operating Environment:

The system is typically comprised of a central server that is connected by a data network to a computer of a user (e.g. smart phone user). The central server can be comprised of one or more computers connected to one or more mass storage devices. The precise architecture of the central server does not limit the claimed invention. Further, the computer of the user (i.e. smart phone user) can be a laptop or desktop type of personal computer. It can also be a cell phone, smart phone or other handheld device, including a tablet. The precise form factor of the users computer does not limit the claimed invention. Examples of computing systems, environments, and/or configurations that may be suitable for use with the invention include, but are not limited to, personal computers, server computers, handheld, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The precise form factor of the computer of the user does not limit the claimed invention. In one embodiment, the computer of the user is omitted, and instead a separate computing functionality provided that works with the central server. In this case, a user would log into the server from another computer and access the system through a user environment.

The user environment can be housed in the central server or operatively connected to it. Further, the user can receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customers actuation of the browser user interface. Some steps of the invention may be performed on the user's computer and interim results transmitted to a server. These interim results may be processed at the server and final results passed back to the user.

The methods described herein can be executed on a computer system, generally comprised of a central processing unit (CPU) that is operatively connected to a memory device, data input and output circuitry (I/O) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The I/O devices can include a display screen, loudspeakers, microphone and a movable mouse that indicate to the computer the relative location of a cursor position on the display and one or more buttons that can be actuated to indicate a command.

The computer can display on the display screen operatively connected to the I/O circuitry the appearance of a user interface. Various shapes, text and other graphical forms are displayed on the screen as a result of the computer generating data that causes the pixels comprising the display screen customer's actuation of the browser user interface. Some steps of the invention can be performed on the user's computer and interim results transmitted to a server. These interim results can be processed at the server and final results passed back to the user.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application. The precise architecture of the central server does not limit the claimed invention. In addition, the data network may operate with several levels, such that the user's computer is connected through a fire wall to one server, which routes communications to another server that executes the disclosed methods.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as C, C-HF, C#, Action Script, PHP, EcmaScript, JavaScript, JAVA, or 5 HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The embodiments may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The embodiments may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated but connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database may be housed in one or more operatively connected servers operatively connected to computer memory, for example, disk drives. In yet another embodiment, the initialization of the relational database may be prepared on the set of servers and the interaction with the user's computer occur at a different place in the overall process.

It should be noted that the flow diagrams are used herein to demonstrate various aspects of the invention, and should not be construed to limit the invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

It will be appreciated that variations of the above disclosed and other features and functions, or altematives thereof, may be combined into other systems or applications. Also, various unforeseen or unanticipated alternatives, modifications, variations or improvements therein may be subsequently made by those skilled in the art which are also intended to be encompassed by the following claims.

Although embodiments of the current disclosure have been described comprehensively, in considerable detail to cover the possible aspects, those skilled in the art would recognize that other versions of the disclosure are also possible.

What is claimed is:

1. A method for characterizing a user of a handheld device, the method comprising:
collecting data from the environment, use, movement or location of a handheld device;
analyzing the data to determine at least one emotion of the user based on activities and/or behaviors;
analyzing the data to determine at least one habit of the user based on the patterns of activities of the user and tendencies of behaviors of the user; and
analyzing the data to determine at least one personality based on long term behavior of the user and/or emotional characteristics of the user;
wherein the at least one emotion, the at least one habit and the at least one personality are stored in a memory for characterizing the user.

2. The method of claim 1, wherein the at least one emotion is determined from a first time period, the at least one habit is determined from a second time period and the at least one personality is determined from a third time period,
wherein the second time period is longer than the first time period and the third time period is longer than the second time period.

3. The method of claim 2, wherein the duration of the first period, the duration of the second period and/or the duration of the third period can be adjusted by the user.

4. The method of claim 1, wherein the data is collected from at least one of a camera, a microphone, an accelerator, a global positioning system (GPS) and software applications operating in active sensing and/or passive sensing modes.

5. The method of claim 1, wherein a fusion algorithm is used in analyzing the data.

6. The method of claim 1, wherein the memory comprises a digital profile card that is at least partially encrypted.

7. The method of claim 1, wherein the memory comprises a digital profile card that includes data on the present location of the handheld device.

8. The method of claim 1, wherein the memory comprises a digital profile card that is stored and/or accessed using cloud technology.

9. The method of claim 1, further comprising distributing the at least one emotion, the at least one habit and the at least one personality to a content provider or vendor.

10. The method of claim 1, further comprising using the at least one emotion, the at least one habit and the at least one personality to select personalized digital content for the user.

11. The method of claim 1, wherein the handheld device is a smart phone, a tablet computer, a personal digital assistant, a cellular phone or a portable computer.

12. A handheld device for characterizing a user comprising:
an image sensor;
a microphone;
an accelerator;
a global positioning system (GPS);
one or more computer applications; and
a digital profile card;
wherein data is collected from the image sensor, the microphone, the accelerator, the GPS and the one or more computer applications and analyzed by the handheld device to identify actions, movement and locations of the user, and
wherein the actions, movement and locations of the user are used to identify one or more emotions, one or more habits and one or more personalities of the user that are stored on the digital profile card.

13. The handheld device of claim 12, wherein the one or more emotions, the one or more habits and the one or more personalities of the user are used to select personalized digital content to present to the user.

14. The handheld device of claim 12, wherein a fusion algorithm is used to identify the one or more emotions, the one or more habits and the one or more personalities of the user.

15. The handheld device of claim 12, wherein the digital profile card includes data on a present location of the user.

16. The handheld device of claim 12, wherein the digital profile card is at least partially encrypted.

17. The handheld device of claim 12, wherein the digital profile card is stored and/or accessed using cloud technology.

18. The handheld device of claim 12, wherein the image sensor, the microphone, the accelerator, the global positioning system (GPS) and the computer with one or more computer applications operate in active sensing and/or passive sensing modes.

19. The handheld device of claim 12, wherein the handheld device is a smart phone, a tablet computer, a personal digital assistant, a cellular phone or a portable computer.

20. A system for targeted advertisement to a user, the system comprising
the handheld device of claim 12;
a database of advertisements; and
one or more authorized devices;
wherein one or more advertisements are selected from the database of advertisements based on the data contained on the digital profile card, and
wherein the one or more advertisements are displayed on the one or more authorized devices.

21. The system of claim 20, further comprising a signal processing unit that decrypts the digital profile card.

22. The system of claim 20, wherein the one or more authorized devices are digital displays or IOT devices.

23. A system for targeted advertisement to an individual based on handheld device use of the individual, the system comprising:
a sensor to detect a handheld device with a digital profile card;
a signal processing unit;
a database of advertisements; and
one or more digital signs/displays;
wherein the signal processing unit decrypts data on the digital profile card, and
wherein one or more advertisements are selected from the database of advertisements by the signal processing unit based on the decrypted data and displayed on the one or more digital signs/displays.

24. The system of claim 23, wherein the digital profile card stores one or more emotions, one or more habits and one or more personalities of the individual.

25. The system of claim 24, wherein a fusion algorithm is used to identify the one or more emotions, the one or more habits and the one or more personalities of the individual based on data collected from an image sensor, a microphone, an accelerator, a global positioning system (GPS) and/or one or more computer applications of the handheld device.

26. The system of claim 23, wherein the digital profile card is at least partially encrypted.

27. The system of claim 23, wherein the digital profile card is stored and/or accessed using cloud technology.

28. The system of claim 24, wherein each of the one or more emotions, the one or more habits and/or the one or more personalities of the individual are ranked according to certainty and/or relevance.
